(19) United States
(12) Patent Application Publication
(10) Pub. No.: US 2003/0007770 A1
(43) Pub. Date: Jan. 9, 2003

(54) Optical fiber array and process for production thereof

(75) Inventors: Akira Matsumoto, Nagoya-city (JP); Masashi Fukuyama, Inuyama-city (JP); Kazutoshi Tohyama, Nakatsugawa-city (JP)

Correspondence Address: BURR & BROWN, PO BOX 7068, SYRACUSE, NY, 13261-7068, US

(73) Assignee: NGK Insulators, Ltd.

(21) Appl. No.: 09/791,494

(22) Filed: Feb. 22, 2001

(51) Int. Cl. G02B 6/36

(52) U.S. Cl. 385/137; 385/83

(57) ABSTRACT

An optical fiber array having: a lower substrate with V-grooves formed; and an upper substrate configured by a fiber presser substrate for pressing optical fibers disposed on the V-grooves, and a coated-fiber settling substrate for settling coated fibers 13. On the coated-fiber settling substrate, a slit or a groove is formed. With this optical fiber array, damages or the like of constituents are avoided and an excellent long-term reliability is attained.

### BACKGROUND OF THE INVENTION AND RELATED ART STATEMENT

The present invention relates to an optical fiber array wherein optical fibers are fixed and arrayed in V-grooves, and to a method of manufacturing the optical fiber array.

In recent years, the movement in multiplying cores for a planar lightwave circuit(PLC) has been progressed in accordance with high densification of optical fibers. To avoid an enlargement in the size of waveguide element channel in accordance with the movement in multiplying cores and further achieve the densitification thereof, the development of a PLC is forwarded to the direction for shortening a conventional standard waveguide channel pitch. And, in conformity to such a movement for high densification in optical fibers and shortening the pitch in waveguide channel, the development is forwarded also to the direction for shortening the inter-fiber pitch in the optical fiber array connected to the optical fiber.

FIGS. 5(a) and 5(b) show one example of half-pitched fiber array wherein the conventional pitch is shortened to a half; FIG. 5(a) showing a perspective view, and FIG. 5(b) showing a sectional view, respectively. The V-grooves 14 are formed on a lower substrate 10, a coated-fiber settling substrate 15 is bonded and fixed from above a coated optical fiber support part 12 of the lower substrate 10, while a coated fiber 13 is inserted through a coated-fiber settling groove 17 formed on the coated-fiber settling substrate 15 and bare uncoated optical fibers are arrayed in the V-grooves 14 of the lower substrate 10. Then, from above the V-grooves 14 of the lower substrate 10, a fiber presser substrate 11 is provided and fixed to form an optical fiber array 22. Here, the fiber presser substrate 11 and the coated-fiber settling substrate 15 shall be both referred to as an upper substrate 18 together.

In the above case, after an optical fiber (coated fiber 13) is inserted in between the upper substrate 18 and the lower substrate 10, there is generally used a method comprising the steps of injecting an UV-setting adhesive into the gaps 21 among these upper substrate 18, lower substrate 10 and optical fibers (hereinafter, referred to as “adhesive filling portions”) and then curing the UV-setting adhesive under UV irradiation to fix individual members. Curing of this adhesive is performed by the UV irradiation to the adhesive.

Here, a contraction occurs on hardening of the adhesive. Such a contraction of an adhesive is in the order of 5 to 10% for acryl derivatives and 1 to 5% even for epoxy derivatives having a small in contraction. Here, epoxy adhesives are small in contraction ratio but hard, whereas acryl adhesives are sometimes soft but great in contraction ratio and consequently the same ratio of curing contraction stress will take place for both. Besides, also by thermal expansion/thermal contraction of an adhesive accompanying a change in the environmental temperature of use for a fiber array, a deformation stress occurs.

Since the strength of a coated-fiber settling substrate and a lower substrate is not always low, either is to a certain extent durable for the contraction stress occurring at the curing of such an adhesive and for the deformation stress due to thermal expansion/thermal contraction generated by a change in temperature or the like among the environments of use after the curing. By action of a stress above a fixed limit, however, a crack 19 occurs on a thin coated-fiber settling substrate 15 in certain cases as shown in the perspective view of FIG. 6, thus damaging the settling substrate 15. Since this damage occurs on account of an instantaneous stress liberation, troubles such as breakage of a bare optical fiber may be caused at the damage and therefore a critical problem happens.

The present invention was invented in consideration of the above-described problems in the prior art and its purpose is to provide an optical fiber array with the stress occurring in an adhesive filling portion relieved, excellent in reliability, and a manufacturing method thereof.

### SUMMARY OF THE INVENTION

Namely, according to the present invention, there is provided an optical fiber array having a lower substrate with V-grooves formed; and an upper substrate configured by a fiber presser substrate for pressing optical fibers disposed on the V-grooves, and a coated-fiber settling substrate for settling coated fibers, characterized in that a slit or a groove is formed on the coated-fiber settling substrate.

In such an optical fiber array, it is also preferable to employ one filled with a low-strength resin in the slit or groove. Besides, it is also preferable to employ a structure in which the coated-fiber settling substrate and the lower substrate are bonded with an elastic resin.

Besides, according to the present invention, there is provided a preferable manufacturing method of the above optical fiber array, i.e. a manufacturing method of an optical fiber array having a lower substrate with V-grooves formed, an upper substrate configured by a fiber presser substrate for pressing optical fibers disposed on the V-grooves, and a coated-fiber settling substrate for settling a coated fiber, characterized by including a step of forming a slit or a groove on the coated-fiber settling substrate by a grindstone grinding or a press forming.

### BRIEF DESCRIPTION OF THE DRAWINGS

FIG. 1 is a perspective view showing one embodiment of an optical fiber array according to the present invention;

FIGS. 2(a) and 2(b) are sectional views showing modified configurations of a coated-fiber settling substrate in an optical fiber array according to the present invention;

FIGS. 3(a), 3(b) and 3(c) are sectional views showing various groove-shaped configurations formed on a coated-fiber settling substrate in an optical fiber array according to the present invention;

FIGS. 4(a) and 4(b) show another embodiment of the optical fiber array according to the present invention, represented in perspective and sectional views, respectively;

FIGS. 5(a) and 5(b) show one example of a half-pitched fiber array, represented in perspective and sectional views, respectively; and

FIG. 6 is a perspective view showing an occurring state of a crack in a conventional half-pitched fiber array.

### DETAILED DESCRIPTION OF PREFERRED EMBODIMENT

Hereinafter, referring to the drawings, embodiments of the present invention will be described, but the present invention is not limited to these embodiments.

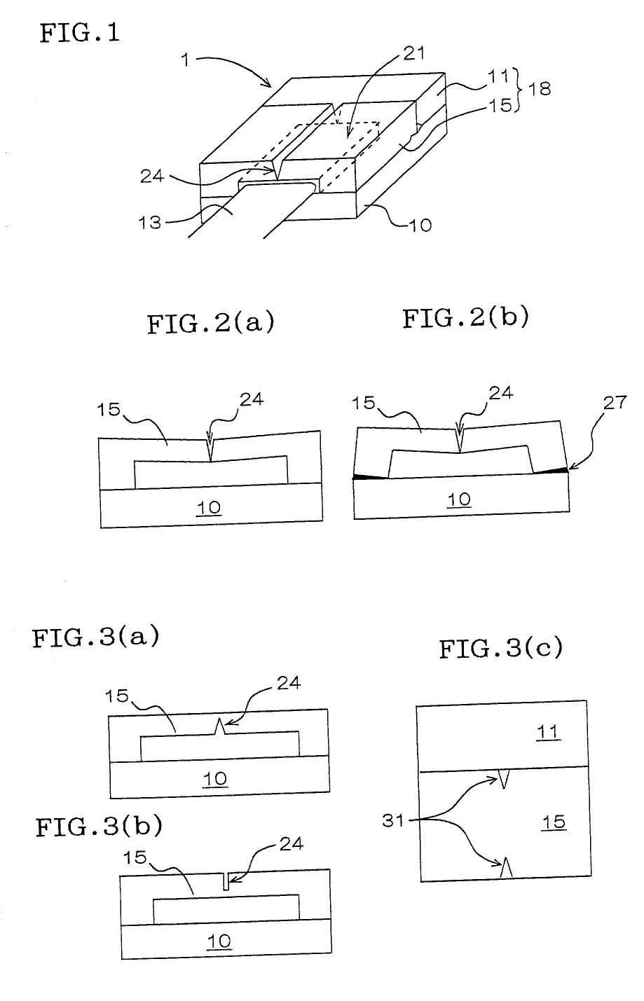

FIG. 1 is a perspective view showing one embodiment of an optical fiber array 1 according to the present invention. As with the optical fiber array 22 shown before in FIGS. 5(a) and 5(b), the optical fiber array 1 is equipped with a lower substrate 10 with V-grooves (not depicted) formed thereon and an upper substrate 18 comprising a fiber presser substrate 11 for pressing uncoated (bare) optical fibers (not depicted) disposed on the V-grooves and a coated-fiber settling substrate 15 for settling a coated optical fiber 13.

And, from a coated-fiber settling groove 17 formed on the coated-fiber settling substrate 15, a coated optical fiber 13 is inserted and bare optical fibers are arrayed in the V-grooves, so that an optical fiber array 1 is constructed. Into an adhesive filling part 21, which is the gaps among the upper substrate 18, the lower substrate 10 and the optical fibers (the bare optical fibers and the coated optical fiber 13), various adhesives are injected using the capillarity and cured.

Here, at the center of the coated-fiber settling substrate 15 in the optical fiber array 1, a groove 24 is formed in parallel with the inserting direction of the coated optical fiber 13. When this groove 24 receives the stress during the curing and contraction of the adhesives, a bottom of the groove 24 is easily broken, the coated-fiber settling substrate 15 is divided and the stress is set free at a low time point of the occurring stress. Reversibly saying, it is required that, on the grooves formed in an optical fiber array according to the present invention, the coated-fiber settling substrate 15 is so designed that the breakage should easily occur at the groove portion in accordance with the curing and contraction of the adhesives.

If described in more detail, the start of curing of the adhesives induces a breakage in the grooves 24 at the stage of a relatively low stress condition during the initial curing of the adhesives, thus dividing the coated-fiber settling substrate 15, because the mechanical strength is small at the forming position of the grooves 24. Here, if the coated-fiber settling substrate 15 is so constructed that it is bent to deform with the curing progress of the adhesives as shown in the sectional view of FIG. 2(a), this deformation leads to the occurrence of strain relief.

Alternatively, if the curing of adhesives in the adhesive filling part is started with the state of preliminarily fixing the coated-fiber settling substrate 15 with groove 24 formed thereon to the lower substrate 10 by using an elastic adhesive 27, the elastic adhesive 27 alone is deformed without deformation of the coated-fiber settling substrate 15 itself as shown in the sectional view of FIG. 2(b) when the groove 24 is broken and the curing of adhesives advances, thereby enabling the stress relief to be attained also.

Like this, even if the coated-fiber settling substrate 15 is allowed to be broken at the stage of a relatively low stress condition during the initial curing of the adhesives, no abrupt stress is applied directly to and damages the bare optical fibers and at the same time the stress of the adhesives is also set free, so that products excellent in long-term reliability are obtained. Furthermore, also in view of the afforded effect of relieving a stress to the thermal expansion/thermal contraction due to a change in temperature or the like under the environments of use after the curing, the groove 24 contributes to an improvement in long-term reliability.

Incidentally, the shape of the grooves 24 is not limited to such a V-shape as shown in FIGS. 1, 2(a) and 2(b) and a similar effect can be obtained even for such a reversed V-shaped groove as shown in the sectional view of FIG. 3(a) or for such a concave-type groove as shown in the sectional view of FIG. 3(b). Furthermore, FIG. 3(c) is a plan view from above the upper substrate 18, and it is also preferable to form an easily breakable structure by forming grooves 31 on both bottoms opposed to each other and allowing a crack to easily occur between these bottoms.

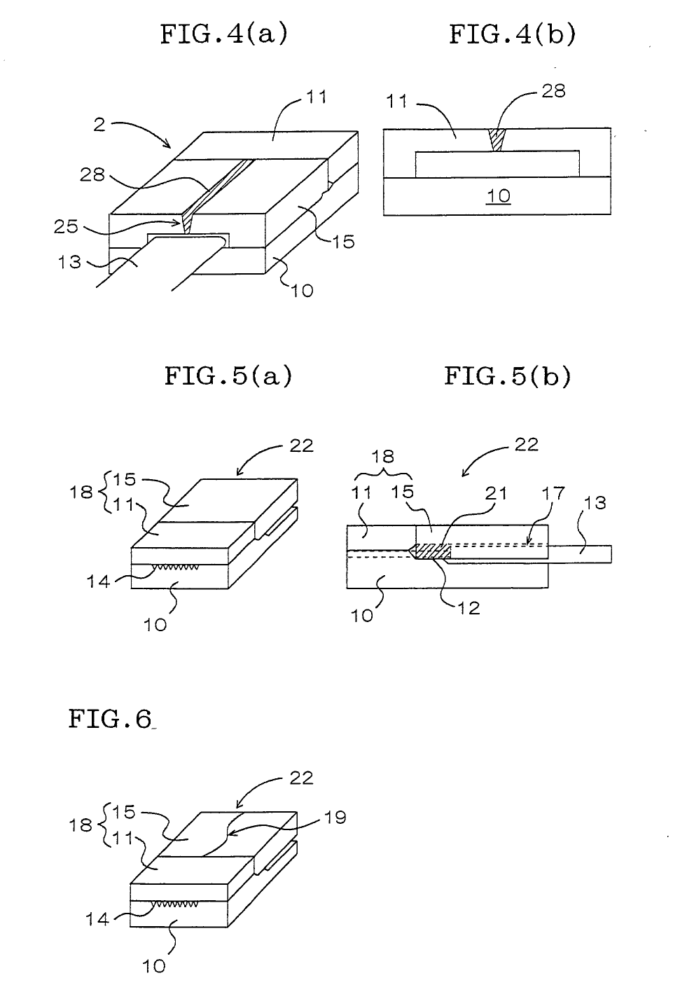

FIGS. 4(a) and 4(b) are perspective and sectional views of an optical fiber array 2 showing another embodiment of the present invention, respectively. The optical fiber array 2 is so structured that a slit 25 is formed which provides a space for dividing the coated-fiber settling substrate 15 perpendicularly with respect to the inserting direction of the coated optical fiber 13 and is filled with a low strength resin 28. In brief, the coated-fiber settling substrate 15 is so structured that two members having approx. L-shaped cross-section are bonded to each other with a low strength resin 28.

Adherence of such a coated-fiber settling substrate 15 to the lower substrate 10 may be performed firmly. On the other hand, it is also preferable to fix the coated-fiber settling substrate 15 to the substrate 10 by using an elastic adhesive. Principally by deformation of a low-strength resin 28 in case of the former adhesion method and by deformation of an elastic adhesive and/or a low-strength resin 28 in the latter adhesion method, relief of a contraction stress or the like in the adhesive filling part is achieved together, and products excellent in long-term reliability are obtained as the above optical fiber array

Incidentally, in the term of stress remaining, bending occurred at a coated-fiber settling substrate 15 under the contraction stress of an adhesive in the case of the conventional undivided structure in the coated-fiber settling substrate 15, and this bending signified an equilibrium state of a restoring force and the contraction stress of the adhesive. However, there was a fear of the peeling-off in the inside interface of the coated-fiber settling substrate 15 and the adhesive due to the collapse of stress balance from the long-term standpoint, because of the influence of the environments of use, such as, for example, the influence of a temperature, a humidity or the like.

On contrary to this, the various bending or deformation states of coated-fiber settling substrates 15 shown in FIG. 2 as mentioned above with respect to an optical fiber array according to the present invention coincides with the contracted portion of the adhesive to form an applied state of no stress, so to speak, a stress-free state. Thus, also from such a point of view, an optical fiber array according to the present invention is improved in long-term reliability.

In forming the above-described groove or slit on a coated-fiber settling substrate, it is preferable to use the grindstone grinding or the press forming for practicing. With the grindstone grinding, the groove conforming to the shape of a grindstone can be formed and one piece of coated-fiber settling substrate can be easily cut off. Besides, with the press forming, a coated-fiber settling substrate can be obtained while forming any shape of groove or slit in accordance with the shape of a mold. Incidentally, the press forming includes both the case of subjecting a melt (fluid) directly to forming press and the press forming of re-pressing a part formed in a fixed shape while re-heating it.

Meanwhile, the above-described upper and lower substrates 18 and 10 for forming an optical fiber array 1 according to the present invention are made of a light transmission material and a glass material or a plastic material, for example, can be used. Thus, filling and curing of a UV-setting adhesive is easily performable in the adhesive filling part 21. There is no limitation to the irradiating direction of UV rays, however, it is preferable to irradiate UV ray in a parallel direction with the inserting direction of optical fibers into an optical fiber array as disclosed before by the present inventors in Japanese Patent Application No. 11-54535 because the contraction stress itself caused by the generation of an adhesive can be reduced.

Furthermore, in order to raise the reliability of an optical fiber array still more, it is also preferable to use different types of adhesives between a first adhesive for bonding a fiber presser substrate 11 to the V-groove part of the low substrate 10 and a second adhesive to be filled in an adhesive filling part 21.

As mentioned above, the contraction stress occurring manifests no large difference in magnitude between the case of using an epoxy adhesive and the case of using an acryl or silicon adhesive to the same portion, however, in the case where adhesives are considered to be used in two places different in the filling amount of the respective adhesives, as a second adhesive greater in filling quantity, it is preferably to use one having a small contraction ratio (a change in volume is small) during the curing/contraction as much as possible and a small thermal expansion after the curing as well, within such a range that the adhesion strength is retained. On the other hand, because the first adhesive is smaller in filling quantity, even an adhesive having a large Young's modulus and relatively large contraction ratio can be used.

With an optical fiber array and a manufacturing method according to the present invention, as described above, relief of the contraction stress occurring during the curing of the adhesives used at the time of assembling the optical fiber array is achieved, keeping a nearly stress-free state becomes possible; and simultaneously, the stress relief is achieved also for the thermal expansion/thermal contraction caused by a change in temperature or the like under the environments of use, so that damages, breakage and peeling of members constituting the optical fiber array and damages of the optical fiber array are avoided, thereby providing a significant effect of assuring an excellent long-term reliability.

What is claimed is:

1. An optical fiber array having:
a lower substrate with V-grooves formed; and
an upper substrate configured by a fiber presser substrate for pressing optical fibers disposed on the V-grooves, and a coated-fiber settling substrate for settling coated fibers,
characterized in that a slit or a groove is formed on the coated-fiber settling substrate.

2. The optical fiber array as set forth in claim 1, wherein a low-strength resin is filled in said slit or said groove.

3. The optical fiber array as set forth in claim 1, wherein said coated-fiber settling substrate and said lower substrate are bonded by an elastic resin.

4. A manufacturing method of an optical fiber array, having:
a lower substrate with V-grooves formed; and
an upper substrate configured by a fiber presser substrate for pressing optical fibers disposed on the V-grooves, and a coated-fiber settling substrate for settling coated fibers,
characterized by including a step of forming a slit or a groove on the coated-fiber settling substrate by a grindstone grinding or a press forming.
